(19) United States
(12) Patent Application Publication
(10) Pub. No.: US 2025/0100095 A1
(43) Pub. Date: Mar. 27, 2025

(54) Changer for tools or workpieces of a machine tool and method for operating such a changer

(71) Applicant: ADELBERT HAAS GMBH, Trossingen (DE)

(72) Inventors: Sergii PASTERNAK, Villingen-Schwenningen (DE); Reinhard ENDRES, Peissenberg (DE); Gerhard SCHNEE, Denking (DE); Dirk WEMBER, Rottweil (DE)

(21) Appl. No.: 18/891,461

(22) Filed: Sep. 20, 2024

(30) Foreign Application Priority Data
Sep. 25, 2023 (DE) 102023125940.7

(51) Int. Cl. B23Q 3/155

(52) U.S. Cl. CPC B23Q 3/15503

(57) ABSTRACT

A changer (100) for tools (112, 122, 132, 142, 152, 162) or workpieces of a machine tool includes a plurality of holders (111, 121, 131, 141) for tools (112, 122, 132, 142, 152, 162) or workpieces, which are arranged rotatably about a common axis of rotation (D), in which the relative position of the holders (111, 121, 131, 141) for tools (112, 122, 132, 142, 152, 162) or workpieces to one another is variable, so that the distance between a first holder (111, 121, 131, 141) and the holders (111, 121, 131, 141) for tools (112, 122, 132, 142, 152, 162) or workpieces neighboring this first holder (121, 131, 141, 111) for tools (112, 122, 132, 142, 152, 162) or workpieces is different at different positions of the first holder (111, 121, 131, 141) for tools (112, 122, 132, 142, 152, 162) or workpieces.

The invention relates to a changer for tools or workpieces of a machine tool and method for operating such a changer.

For reasons of time and cost, but also for safety reasons, the aim is increasingly to ensure that the machining of workpieces with the tools of a machine tool is largely automated. In many cases, modern machine tools therefore have a changer for tools or workpieces to enable tools or workpieces to be exchanged without interfering with the machining area of the machine tool.

In a common design of such changers for tools or workpieces of a machine tool, a plurality of holders for tools or workpieces are provided, each of which is arranged on a carrier structure at the same distance from a common axis of rotation, for example a disk as disclosed in EP 2 060 359 B1 or a cross as disclosed in DE 20 2023 102 829 U1, and are rigidly connected to one another.

To exchange a tool or workpiece
the tool or workpiece that is to be exchanged is received in a free holder of the changer, for example gripped with a gripper,
its fixation in the tool spindle or workpiece spindle is overridden and the tool or workpiece is removed from the tool spindle or workpiece spindle by a movement parallel to the axis of the tool spindle or workpiece spindle,
the holders of the carrier structure are rotated about the common axis of rotation to the position of the next tool or workpiece to be inserted,
the next tool or workpiece is inserted into the tool spindle or workpiece spindle by a movement parallel to the axis of the tool spindle or workpiece spindle, fixed there and released from the holder, for example, by a gripper letting go, and
the tool or workpiece is transferred to the machining position.

A substantial parameter for achieving high machining speeds is the minimization of travel paths when operating the machine tool. This leads to a dilemma when designing the carrier structure for the holders of the changer.

If a disk is chosen, as in EP 2 060 359 B1, it is possible to provide the changer with a large number of holders. However, there is no space between these holders, which leads to a large relative movement between the changer and the spindle needing to be implemented before machining can begin, this in order to prevent the changer from interfering with machining and creating a risk of collision with the spindle.

If, instead, a cross-shaped structure is chosen, the travel paths can be minimized, as described, for example, in DE 20 2023 102 829 U1, however, the number of tools that can be kept at ready on the changer is more limited.

Accordingly, the task of the invention is to provide a changer for tools or workpieces of a machine tool and a method for operating such a changer which enables short travel distances, reduces the risk of collision with the spindle and at the same time provides more holders for tools or workpieces.

This task is solved by a changer for tools or workpieces of a machine tool with the features of patent claim 1 and by a method for operating such a changer with the features of patent claim 7. Advantageous further developments of the invention are the subject of the dependent patent claims.

The changer for tools or workpieces of a machine tool according to the invention comprises a plurality of holders for tools or workpieces which are arranged rotatably about a common axis of rotation, so that during the execution of a rotation about this axis, all the holders for tools or workpieces change their position.

This does not, however, require that the change in position of all holders for tools or workpieces is changed in the same way, but rather merely requires that these changes in position are brought about at least in part by the movement of the same driven axis of rotation. In other words, the feature means that the holders for tools or workpieces are arranged rotatably about a common axis of rotation, which is to say, that all holders for tools or workpieces change their spatial position during a rotation about this axis of rotation, wherein not all position changes are necessarily caused solely by this rotation.

It is essential to the invention that the relative position of the holders for tools or workpieces to one another is variable, so that the distance between a first holder for tools or workpieces and the holders for tools or workpieces neighboring this first holder for tools or workpieces is different at different positions of the first holder for tools or workpieces.

In principle, such variations in distance can obviously be brought about in different ways; in particular, by a change of the angle between the connecting lines of the respective holder for tools or workpieces to the common axis of rotation of two neighboring holders for tools or workpieces or by a change of the distance of respective holders for tools or workpieces to the common axis of rotation.

In this way, the possibility is achieved to arrange holders for tools or workpieces close together on the side of the changer facing away from the tool spindle or workpiece spindle in a changer arranged on the machine tool, so that a larger number of tools or workpieces can be arranged in the changer, whereas the distance of one holder for tools or workpieces from its neighbors can be increased, in particular, in the position in which a tool or workpiece is transferred over to or taken from the tool spindle or workpiece spindle, so that sufficient space is available during machining and certain travel paths can be avoided to prevent collisions.

In principle, this can be realized by including individual drives for the individual holders for tools or workpieces; it is, however, preferable that a common drive is available to bring about the rotations of the holders for tools or workpieces about the common axis of rotation, inasmuch costs are thereby saved and this simplifies the coordination of the movements of the holders for tools or workpieces.

Electric, hydraulic, pneumatic or combined drives are particularly suitable as a common drive.

A first preferred variant for realizing the variation of the relative positions of the holders for tools or workpieces to each other is that the common drive drives the holders for tools or workpieces by means of cam disks or a cam guide.

In an alternative variant, the relative position of the holders for tools or workpieces to each other is varied thereby, in that the common actuator drives the holders for tools or workpieces by means of planetary gear drives.

The possibility of varying the distances between the holders for tools or workpieces is used particularly effectively when the distance between a given holder for tools or workpieces and the holders for tools or workpieces neighboring this given holder for tools or workpieces is greatest, when the given holder for tools or workpieces is in the position in which it is closest to the tool spindle or workpiece spindle.

In the method according to the invention for operating such a changer for tools or workpieces of a machine tool, the tool or workpiece that is to be exchanged, which is currently located in the tool spindle or workpiece spindle, is received in a free holder for tools or workpieces of the changer in order to change a tool or workpiece that is to be exchanged. Preferably, this is the holder for tools or workpieces from which this tool or workpiece was also inserted into the spindle and which has essentially remained in the hand-over position during machining. Preferably, the holder for tools or workpieces is configured as a gripper, so that the workpiece or tool can be received simply by clasping the gripper.

In the method according to the invention, the fixation of the tool to be exchanged in the tool spindle or workpiece spindle is, moreover, overridden and the tool or workpiece is removed from the tool spindle or workpiece spindle by a movement parallel to the axis of the tool spindle or workpiece spindle. This can preferably happen together with cooling lubricant nozzles, which can be individually adapted to the respective tool and connected to it.

In order to transfer the new tool or workpiece to the hand-over position, the holders for tools or workpieces of the carrier structure are, in particular, rotated about the common axis of rotation so that the holder for tools or workpieces in which the new, which is to say, the next tool or workpiece to be used, is located, lies on the axis of rotation of the tool spindle or workpiece spindle, and subsequently the tool or workpiece to be inserted next is inserted into the tool spindle or workpiece spindle by a movement parallel to the axis of the tool or workpiece spindle, is fixed there and is released, for example unclasped, from the holder for tools or workpieces in which the tool or workpiece to be inserted next is received, if the holder is configured as a gripper.

According to the invention, the method is characterized in that at least one of the holders for tools or workpieces of the carrier structure during rotation of the holders for tools or workpieces of the carrier structure about the common axis of rotation is rotated through a different angle of rotation about the common axis of rotation than other holders for tools or workpieces of the carrier structure and/or that at least one of the holders for tools or workpieces of the carrier structure changes its distance from the common axis of rotation during rotation of the holders for tools or workpieces of the carrier structure about the common axis of rotation.

This leads to it becoming possible to adjust the distance between neighboring holders for tools or workpieces in order to arrange tools or workpieces close together at certain positions where this does not interfere, whereas at other positions, the same holder for tools or workpieces is sufficiently far away from the same neighboring holders for tools or workpieces to make collision-free machining of the tool or workpiece possible without needing to move the changer for tools or workpieces out of the way.

It is particularly preferred if the holder for tools or workpieces, which receives the previously used tool or the previously processed workpiece, and/or the holder for tools or workpieces, which receives the tool to be used next or the workpiece to be processed next, is rotated by a greater angle of rotation about the common axis of rotation and/or is positioned at a greater distance from the common axis of rotation than other holders for tools or workpieces.

The invention is elucidated in more detail below with reference to figures showing execution examples. Wherein:

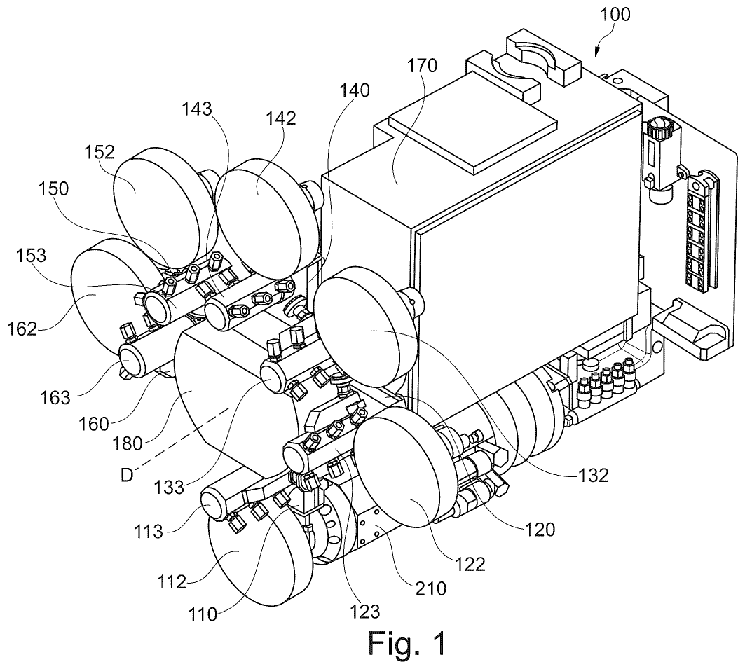

FIG. 1: shows an isometric view of an execution example of a changer;

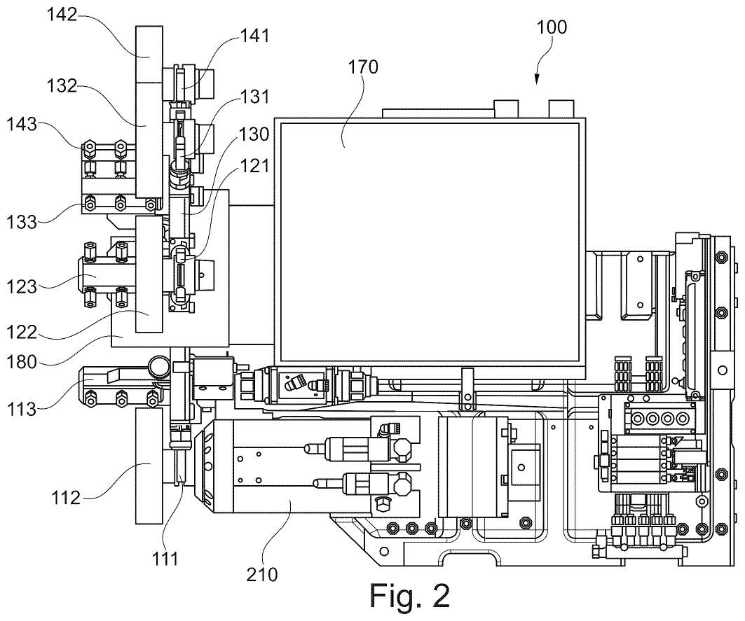

FIG. 2: shows a side view of the changer from FIG. 1;

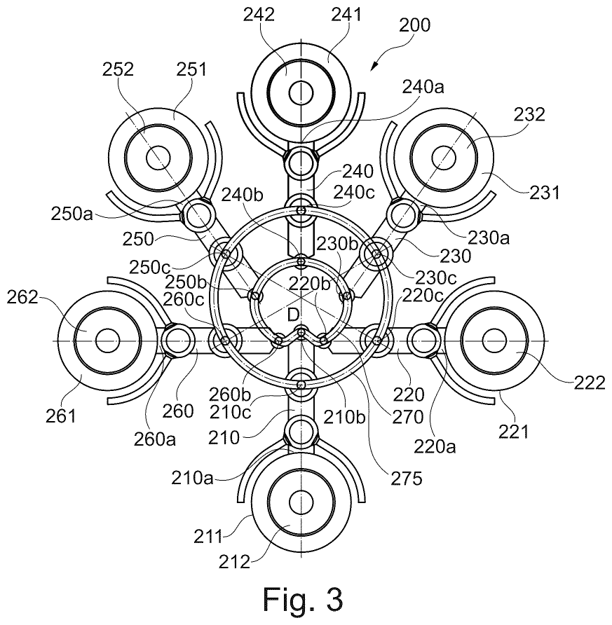

FIG. 3: shows a first possibility for realizing variable relative positions of the tool holders to each other; and

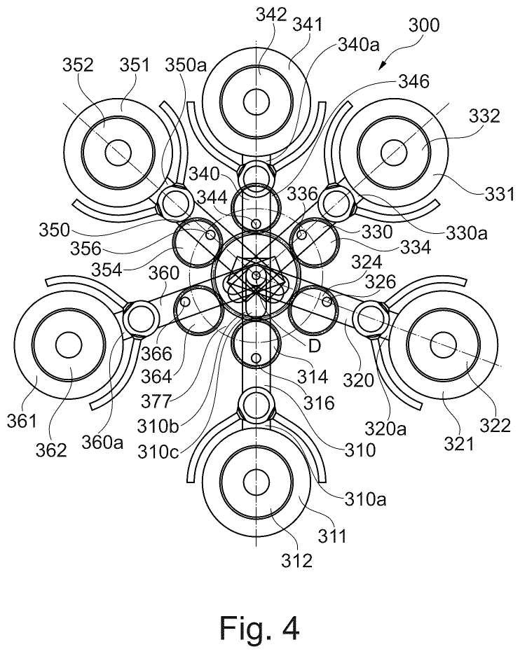

FIG. 4: shows a second possibility for realizing variable relative positions of the tool holders to each other.

Inasmuch as the same execution form of the invention is shown in figures, the same reference signs are respectively used. To improve clarity, not all reference signs are, however, shown in all figures.

The changer 100 shown in the figures is configured as a changer for tools. In this example, it comprises a carrier structure with 6 arms 110, 120, 130, 140, 150, 160, which can be rotated about a common axis of rotation D and to each other; in principle, however, a larger or smaller number of arms (and thus of receivable tools or workpieces) can also be provided.

A common drive, which moves the arms 110, 120, 130, 140, 150, 160 individually depending on their position, and its control system are arranged in a housing 170. Planetary gear drives or cam disks, with which the position-dependent individual movement is realized, are arranged inside the gearbox housing 180 and are therefore not visible.

The fact that the movement of the arms 110, 120 130, 140, 150, 160 is position-dependent means that a given number of rotations of the drive shaft on the one hand moves a given arm 110, 120 130, 140, 150, 160 by a different angle depending on its current position, which also means that the respective arm 110, 120 130, 140, 150, 160 then moves at different speeds.

The fact that the movement of the arms 110, 120 130, 140, 150, 160 is also individual means that different arms 110, 120, 130, 140, 150, 160 move at different angles, as will be elucidated in more detail below using an example.

A holder for tools or workpieces configured as a gripper is respectively arranged at the end of the arms 110, 120, 130, 140, 150, 160 opposite from the common axis of rotation D, but, in FIG. 1, these holders are concealed by the tools 112, 122, 132, 142, 152, 162 received in these holders or, alternatively in the case of the tool 112, received in the tool spindle 190 belonging to the machine tool, with associated cooling lubricant nozzles 113, 123, 133, 143, 153, 163 arranged on them. Only in FIG. 2 can the holders 111, 121, 131 and 141, which are configured as grippers, be recognized, wherein the gripper 111 is just open because the tool 112 is inserted into the tool spindle 190.

In the position of the changer 100 shown in FIG. 1, it is immediately apparent that there are different distances between neighboring tools. The distance between the tool 112 and its neighboring tools 122 and 162 is 90° in each case. In contrast, the distance between the tools 142 and the neighboring tools 152 and 132 is 45°.

If the tool 112 is now to be exchanged with the tool 162, the tool 112 to be exchanged is first gripped by the gripper, which forms the holder 111 and which was free as long as the tool 112 to be exchanged was used in the tool spindle 190, and thereby received in the previously free holder 111. After the fixation of the tool 112 to be exchanged in the tool spindle has been released, the tool can be removed from the tool spindle 190 by a movement parallel to the axis of the tool spindle, which can be realized by the changer 100 or by a linear mechanism of the tool spindle 190. At the same time, a connection to a supply line with cooling lubricant for the cooling lubricant nozzle 113 can also be disconnected.

All arms 110, 120, 130, 140, 150, 160 with the holders 111, 121, 131, 141 arranged on them are then rotated about the common axis of rotation D by the drive so that they are each moved one position further by means of which the holder for workpieces or tools, which is arranged on arm 160, can hand over the tool 162 to the tool spindle 190.

For this purpose, the arm 160 must be moved by 90°. The arm 110 is likewise moved by 90°, so that it ends up in the position at which the arm 120 is shown in the drawing; the arm 120 must be moved by 45° to the position of the arm 130, the arm 130 by 45° to the position of the arm 140, the arm 140 by 45° to the position of the arm 150 and the arm 150 by 45° to the position of the arm 160.

Thereinafter, the next tool 162 can be inserted into the tool spindle 190 by means of a movement parallel to the axis of the tool spindle 190, which can be carried out as described above when pulling out the tool 112, can be fixed there and released from the holder for tools or workpieces realized as a gripper, which previously held the tool 162, by opening the gripper. At the same time, a connection to a supply line with cooling lubricant for the cooling lubricant nozzle 163 can also be established.

Obviously, the holders that hold the tools 162 and 112 have each been rotated by an angle of 90°, whereas the holders that hold the tools 122, 132, 142 and 152 have only been rotated by 45°.

On the basis of FIG. 3, a first possibility for realizing variable relative positions of the tool holders to one another will now be elucidated. The changer 200, shown in FIG. 3, again has six arms 210, 220, 230, 240, 250, 260, at the distal ends 210a, 220a, 230a, 240a, 250a, 260a of which a holder 211, 221, 231, 241, 251, 261 is arranged, respectively with a tool 212, 222, 232, 242, 252, 262 received therein.

The proximal ends 210b, 220b, 230b, 240b, 250b, 260b opposite from the distal ends 210a, 220a, 230a, 240a, 250a, 260a of the arms 210, 220, 230, 240, 250, 260 are mounted in a fixed cam disk 270 in the shape of the forced cam, which is non-circular in configuration. In order for the arms 210, 220, 230, 240, 250, 260 to maintain their position in the fixed forced cam, they are preferably pressed on in order to secure the guide through the fixed forced cam.

The position of the arms 210, 220, 230, 240, 250, 260 is changed by the rotation of a tool changer wheel 275 on which the arms 210, 220, 230, 240, 250, 260 are rotatably attached relative to the tool changer wheel 275 at a point 210c, 220c, 230c, 240c, 250c, 260c between their distal end 210a, 220a, 230a, 240a, 250a, 260a and their proximal end 210b, 220b, 230b, 240b, 250b, 260b, each about an axis of rotation extending parallel to the axis of rotation of the tool changer wheel 275. Preferably, the points 210c, 220c, 230c, 240c, 250c, 260c are respectively equidistant from the proximal end 210b, 220b, 230b, 240b, 250b, 260b of the arms 210, 220, 230, 240, 250, 260.

Depending on the non-circular shape of the fixed cam disk 270, when the tool changer wheel 275 rotates around its axis of rotation, the arms 210, 220, 230, 240, 250, 260 respectively carry out an additional rotation around the axis of rotation running parallel to this axis of rotation through the points 210c, 220c, 230c, 240c, 250c, 260c, which changes the angle between the respective arms 210, 220, 230, 240, 250, 260 as a function of the shape of the cam disk 270, which is configured as a forced cam, so that the distance between a first holder 211, 221, 231, 241, 251, 261 and the holders 261, 221; 211, 231; 221, 241; 231, 251; 241, 261; 251, 211 neighboring this first holder 211, 221, 231, 241, 251, 261 is different at the different positions of the first holder 211, 221, 231, 241, 251, 261 that can be approached by rotation of the tool changer wheel 275.

On the basis of FIG. 4, a second possibility for realizing variable relative positions of the tool holders to one another will be elucidated below. The changer 300, shown in FIG. 4, again has six arms 310, 320, 330, 340, 350, 360, at the distal ends 310a, 320a, 330a, 340a, 350a, 360a of which a holder 311, 321, 331, 341, 351, 361 is arranged, respectively with a tool 312, 322, 332, 342, 352, 362 received therein.

The proximal ends opposite the distal ends 310a, 320a, 330a, 340a, 350a, 360a of the arms 310, 320, 330, 340, 350, 360, of which, for reasons of clarity, only the proximal end 310b of the arm 310 is marked with a reference sign, each have a holder 310c, which is configured as an elongated hole—likewise marked with a reference sign for reasons of clarity only in the case of the arm 310—in which the common axis of rotation D is guided.

The change in the relative position of the six arms 310, 320, 330, 340, 350, 360 is brought about here by a type of planetary gear drive, the sun gear 375 of which has the common axis of rotation D as its axis of rotation. Six planetary gears 314, 324, 334, 344, 354, 364 are mounted in the execution form of FIG. 4 with their axes of rotation in a common ring 377, which is rotatable about the axis of rotation D.

The six planetary gears 314, 324, 334, 344, 354, 364, driven by the sun gear 375, are dimensioned in such a way that they are each rotated once through 360° during a complete revolution of the sun gear 375, if necessary, also with the aid of an intermediate gear not shown in FIG. 4.

This leads to the fact, that the distance from the axis of rotation D of the bearing pins 316, 326, 336, 346, 356, 366 anchored in the respective planetary gear 314, 324, 334, 344, 354, 354, 364, by means of which the planetary gears 314, 324, 334, 344, 354, 364 are each connected to a position lying between the ends of the respective arm 310, 320, 330, 340, 350, 360, varies depending on the current point of the planetary gear 310, 320, 330, 340, 350, 360. In the illustration of FIG. 4, the smallest distance of a bearing pin 316, 326, 336, 346, 356, 366 from the axis of rotation D is reached at a 12 o'clock position in which the arm 340 attached to the bearing pin 346 is straight, whereas the greatest distance of a bearing pin 316, 326, 336, 346, 356, 366 is reached at a 6 o'clock position in which the arm 310 attached to the bearing pin 316 is straight.

Correspondingly, the arms 310, 320, 330, 340, 350, 360 are extended to different extents, which leads to the fact that the distance between a first holder 311, 321, 331, 341, 351, 361 for tools or workpieces, and the holders 311, 321, 331, 341, 351, 361 for tools or workpieces neighboring this first holder 311, 321, 331, 341, 351, 361, for tools or workpieces at different positions of the first holder 311, 321, 331, 341, 351, 361 for tools or workpieces is different and changes when the arms 310, 320, 330, 340, 350, 360 are rotated about the common axis of rotation D by rotating the sun gear 375.

List of reference signs

| | |
|---|---|
| 100, 200, 300 | Changer |
| 110, 120, 130, 140, 150, 160, | Arm |
| 210, 220, 230, 240, 250, 260, | |
| 310, 320, 330, 340, 350, 360 | |
| 111, 121, 131, 141, | Holder |
| 211, 221, 231, 241, 251, 261, | |
| 311, 321, 331, 341, 351, 361 | |
| 112, 122, 132, 142, 152, 162, | Tool |
| 212, 222, 232, 242, 252, 262, | |
| 312, 322, 332, 342, 352, 362 | |
| 113, 123, 133, 143, 153, 163 | Cooling lubricant nozzle |
| 170 | Housing |
| 180 | Gearbox housing |
| 190 | Tool spindle |
| 210a, 220a, 230a, 240a, 250a, 260a, | Distal end |
| 310a, 320a, 330a, 340a, 350a, 360a | |
| 210b, 220b, 230b, 240b, 250b, 260b, | Proximal end |
| 310b | |
| 210c, 220c, 230c, 240c, 250c, 260c | Point |
| 270 | Cam disk |
| 275 | Tool changer wheel |
| 310c | Holder |
| 314, 324, 334, 344, 354, 364 | Planetary gear |
| 316, 326, 336, 346, 356, 366 | Bearing pin |
| 375 | Sun gear |
| D | Axis of rotation |

1. Changer (100, 200, 300) for tools (112, 122, 132, 142, 152, 162, 212, 222, 232, 242, 252, 262, 312, 322, 332, 342, 352, 362) or workpieces of a machine tool, wherein the changer (100, 200, 300) comprises a plurality of holders (111, 121, 131, 141, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces, which are arranged rotatably about a common axis of rotation (D),
characterized in that the relative position of the holders (111, 121, 131, 141, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces to one another is variable, so that the distance between a first holder (111, 121, 131, 141, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces and the holders (111, 121, 131, 141, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces neighboring this first holder (121, 131, 141, 111, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces is different at different positions of the first holder (111, 121, 131, 141, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces.

2. Changer (100, 200, 300) according to claim 1,
characterized in that a common drive for bringing about the rotations of the holders (111, 121, 131, 141, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces about the common axis of rotation (D) is provided.

3. Changer (100, 200, 300) according to claim 2,
characterized in that the common drive is an electric, hydraulic, pneumatic or combined drive.

4. Changer (100, 200, 300) according to claim 2,
characterized in that the relative position of the holders (111, 121, 131, 141, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces to each other is varied thereby, in that the common drive drives the holders (111, 121, 131, 141, 211, 221, 231, 241, 251, 261, 311, 321, 331, 341, 351, 361) for tools (112, 122, 132, 142, 152, 162) or workpieces by means of at least one cam disk (270) or at least one cam guide.

5. Changer (100, 200, 300) according to claim 2,
characterized in that the relative position of the holders (111, 121, 131, 141, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces to each other is varied thereby, in that the common actuator drives the holders (111, 121, 131, 141, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces by means of at least one planetary gear drive.

6. Changer (100, 200, 300) according to claim 1,
characterized in that the distance between a given holder (111, 121, 131, 141, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces, and the holder (111, 121, 131, 141, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces neighboring holders (121, 131, 141, 111) for tools (112, 122, 132, 142, 152, 162, 212, 222, 232, 242, 252, 262, 312, 322, 332, 342, 352, 362) or workpieces is the greatest when the given holder (111, 121, 131, 141, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces is in the position in which it is closest to the tool spindle 190 or the workpiece spindle.

7. Method for operating a changer (100, 200, 300) for tools (112, 122, 132, 142, 152, 162, 212, 222, 232, 242, 252, 262, 312, 322, 332, 342, 352, 362) or workpieces of a machine tool, wherein, in order to change a tool (112, 122, 132, 142, 152, 162) or workpiece that is to be exchanged
the tool (112, 122, 132, 142, 152, 162, 212, 222, 232, 242, 252, 262, 312, 322, 332, 342, 352, 362) or workpiece that is to be exchanged is received in a free holder (111, 121, 131, 141, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces of the changer (100, 200, 300),
the fixation of the tool to be exchanged (112, 122, 132, 142, 152, 162, 212, 222, 232, 242, 252, 262, 312, 322, 332, 342, 352, 362) in the tool spindle (190) or workpiece spindle is overridden and the tool (112, 122, 132, 142, 152, 162, 212, 222, 232, 242, 252, 262, 312, 322, 332, 342, 352, 362) or workpiece is removed from the tool spindle (190) or workpiece spindle by a movement parallel to the axis of the tool spindle or workpiece spindle,
the holders (111, 121, 131, 141, 211, 221, 231, 241, 251, 261, 311, 321, 331, 341, 351, 361) of the carrier structure are rotated about the common axis of rotation (D) so that the holder (111, 121, 131, 141, 211, 221, 231, 241, 251, 261, 311, 321, 331, 341, 351, 361) for tools (112, 122, 132, 142, 152, 162) or workpieces, in which the tool (112, 122, 132, 142, 152, 162, 212, 222, 232, 242, 252, 262, 312, 322, 332, 342, 352, 362) or workpiece to be inserted next is located, is on the axis of rotation of the tool spindle (190) or workpiece spindle, and
the next tool (112, 122, 132, 142, 152, 162, 212, 222, 232, 242, 252, 262, 312, 322, 332, 342, 352, 362) or workpiece is inserted into the tool spindle (190) or workpiece spindle by a movement parallel to the axis of the tool spindle (190) or workpiece spindle, is fixed there and released from the holder (111, 121, 131, 141, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces,
characterized in that at least one of the holders (111, 121, 131, 141, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces of the carrier structure during rotation of the holders (111, 121, 131, 141, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces of the carrier structure about the common axis of rotation (D) is rotated through a different angle of rotation about the common axis of rotation (D) than other holders (111, 121, 131, 141, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces of the carrier structure and/or that at least one of the holders (111, 121, 131, 141, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces of the carrier structure changes its distance from the common axis of rotation (D) during rotation of the holders (111, 121, 131, 141, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces of the carrier structure about the common axis of rotation (D).

8. Method according to claim 7,
characterized in that the holder (111, 121, 131, 141, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces, which receives the previously used tool (112, 122, 132, 142, 152, 162, 212, 222, 232, 242, 252, 262, 312, 322, 332, 342, 352, 362) or the previously processed workpiece, and/or the holder (111, 121, 131, 141, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces, which receives the tool to be used next (112, 122, 132, 142, 152, 162, 212, 222, 232, 242, 252, 262, 312, 322, 332, 342, 352, 362) or the workpiece to be processed next, is rotated through a greater angle of rotation about the common axis of rotation (D) and/or is positioned at a greater distance from the common axis of rotation (D) than other holders (111, 121, 131, 141, 211, 221, 231, 241, 251, 261, 311, 321, 331, 341, 351, 361) for tools (112, 122, 132, 142, 152, 162, 212, 222, 232, 242, 252, 262, 312, 322, 332, 342, 352, 362) or workpieces.
